(19) United States
(12) Patent Application Publication
(10) Pub. No.: US 2007/0241570 A1
(43) Pub. Date: Oct. 18, 2007

(54) Latch and latch striker interface improvements

(76) Inventor: Almantas K. Paskonis, Concord, OH (US)

Correspondence Address: ROETZEL & ANDRESS, 1375 EAST 9TH STREET, CLEVELAND, OH, 44114, US

(21) Appl. No.: 11/732,351

(22) Filed: Apr. 3, 2007

Related U.S. Application Data
(60) Provisional application No. 60/788,595, filed on Apr. 3, 2006.

(51) Int. Cl. E05B 15/02

(52) U.S. Cl. 292/340

(57) ABSTRACT

A latch and latch striker interface including a latch striker which has a contoured bridge configured for insertion into and engagement with the fishmouth of a latch body, at least one wall in the fishmouth being at least partially flexible and flexed or deformed by contact with a contoured or protruding profile of the latch striker bridge for an anti-vibration and anti-chucking interface between the latch striker and latch. A fitted plug attached to the latch striker is configured for partial insertion into the fishmouth of the latch body when the latch striker is engaged with the latch.

### RELATED APPLICATIONS

This application is a conversion of U.S. provisional patent application No. 60/788,595, filed Apr. 3, 2006.

### FIELD OF THE INVENTION

The present invention is in the general field of closures, closure systems, and closure, clasping and latching devices.

### BACKGROUND OF THE INVENTION

Latches which engage with a latch striker to provide a closure mechanism in connection with a door or other opening in a body or panel, typically include a latch body in which a latch mechanism is housed, and which is configured to interface with a latch striker. Most latches have a rotationally mounted clasp which rotates into and out of engagement with a segment of the latch striker. In the crudest form, the latch striker is any fixed structure which the clasp of the latch can engage. Automotive latch design has evolved to locate the latch clasp within a latch body and recessed from a side wall of the latch body, so that the striker must enter to the latch body through an opening in the side wall referred to as a “fishmouth”, in order to engage with the clasp. The interface between the latch striker and the fishmouth of the latch body is the source of many undesirable mechanical properties, particularly in automotive applications, such as too much or too little friction, noise generation, “chucking” which generally refers to relative motion between the latch striker and latch body or clasp when in the latched condition, and motion in other dimensions and degrees resulting from operational vibration.

Although improvements and alterations have been made to both latch and latch striker designs, the prior art does not address improvement of the interface between the latch striker and the latch, and specifically with the fishmouth of the latch body.

### SUMMARY OF THE INVENTION

The disclosure and related inventions are of an improved latch and latch striker interface wherein a bridge of the strikers is configured to contact a flexible wall or flexible area of a wall of the fishmouth of the latch. The contact of the protruding profile of one or both sides of the bridge of the striker with a flexible wall of the fishmouth of the latch provides for an improved fit an engagement which reduces or eliminates noise generation.

In other aspects of the disclosure, the bridge may have a spherical form as well as arcs for those latches needing a ball type detent to prevent vibration and movement. The arc or sphere features causes the mating latch surface to arc or nest around the striker form and thus requires a greater force to move from position when engaged. This causes substantial reduction in vibration and noise due to movement between the latch and striker.

The engagement post can have a formed or pre-assembled ball (spherical shape) on the bridge to engage with latches requiring rotational movement but still a docking feature capability with the latch. The contours or forms of the striker bridge provide a positive limitation on movement by providing a two points or multi point restraint when fully engaged with the latch mechanism.

The latch striker bridge with non-symmetrical features provide load bearing surfaces for reduction in drag when engaging with latch surfaces. This feature allows for a drawer slide type action and will provide detent restraint.

Assembly of the latch striker bridge to base configurations are through a plug and socket features with limit stops formed in the bridge to control position and prevent further movement from compression after assembly. The locking mechanism to base plate is attained by deforming or welding of bridge ends causing a sandwich effect of the base plate by the bridge.

The application of an arc or spherical feature on the striker bridge or engagement post provides a nesting effect like that of a male and female curved surfaces nested together at rest and requiring a lifting or climbing effect between the mating surfaces in order to move linearly apart. The required additional force from rest prevents minor vibratory movement and thus reduces noise and movement.

These and other aspects of the disclosure and inventions are further described herein with reference to the accompanying Figures.

### DESCRIPTION OF THE FIGURES

FIGS. 1-4 are assembly views of portions of a latch at various stages of engagement with a latch striker;

FIGS. 5A and 5B, and 6A and 6B are assembly views of portions a latch and latch striker at various stages of engagement;

FIGS. 7 and 8 are perspective views of one type of latch striker of the disclosure;

FIG. 9 is a perspective view of one type of latch striker of the disclosure;

FIG. 10 is a perspective view of one type of latch striker of the disclosure;

FIG. 11 is a perspective view of one type of latch striker of the disclosure;

FIG. 12 is a plan view of a mounting surface of the latch striker of FIG. 11;

FIG. 13 is a perspective view of one type of latch striker of the disclosure;

FIG. 14 is a perspective view of one type of latch striker of the disclosure;

FIGS. 15A and 15B are profile and perspective views of the heel, bridge and post components of one type of latch striker of the disclosure;

FIGS. 16A and 16B are profile and perspective views of the heel, bridge and post components of one type of latch striker of the disclosure;

FIGS. 17A and 17B are profile and perspective views of the heel, bridge and post components of one type of latch striker of the disclosure, and

FIGS. 18A and 18B are profile and perspective views of the heel, bridge and post components of one type of latch striker of the disclosure.

### DETAILED DESCRIPTION OF REPRESENTATIVE EMBODIMENTS OF THE DISCLOSURE

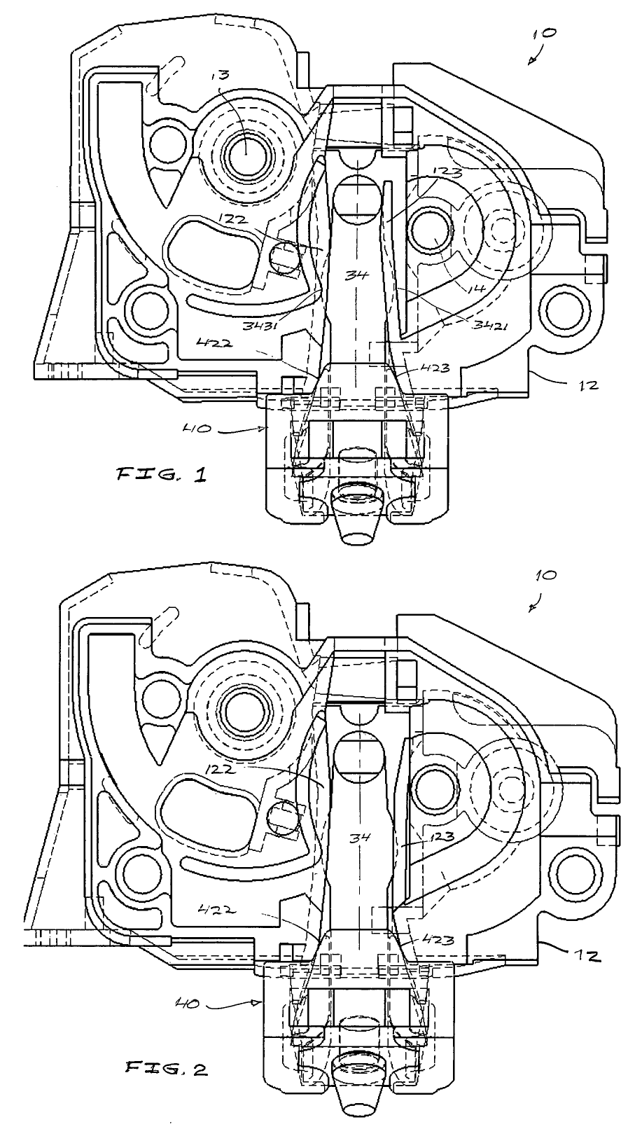

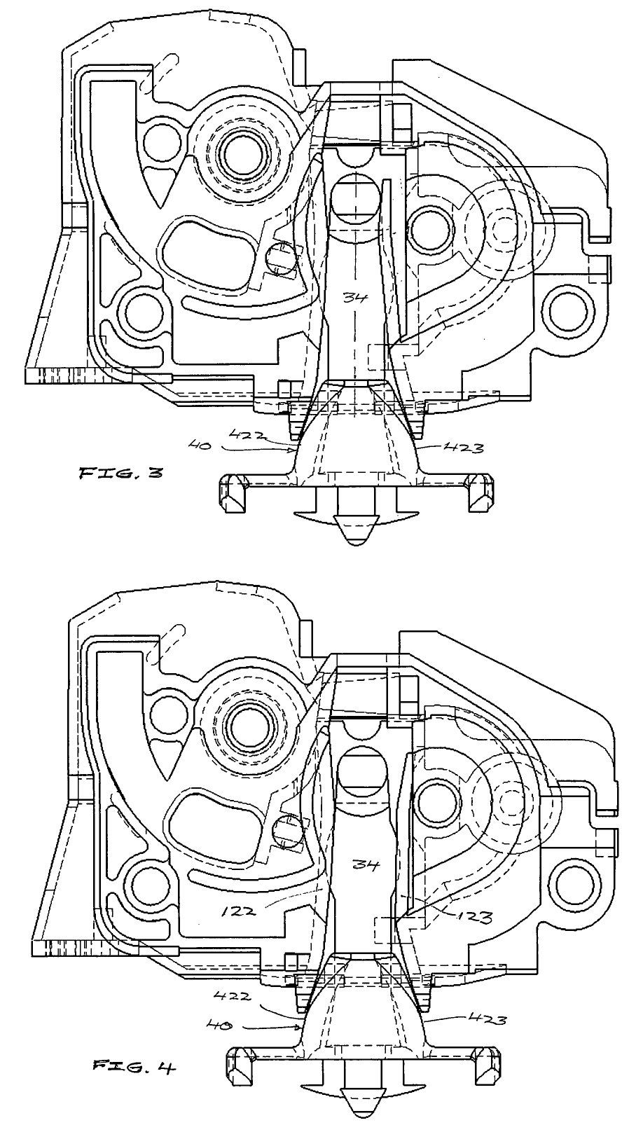

Referring to FIGS. 1 and 2, there is shown a latch, generally indicated at 10, which includes a latch body, generally indicated at 12. The latch body houses latch components such as a catch and pawl (not shown) which are rotationally mounted within the latch body, for example at pins 13 and 14. The disclosure includes any type of latch which operates in cooperation with a latch striker as further described, including but not limited to any of the different types of latches used in automotive applications as for example for passenger compartment door latching and seating and other closure applications. Some representative latches which can be used in accordance with some aspects of the disclosure include automotive latches as produced by produced by the G-Com, Magna and Kiekert corporations.

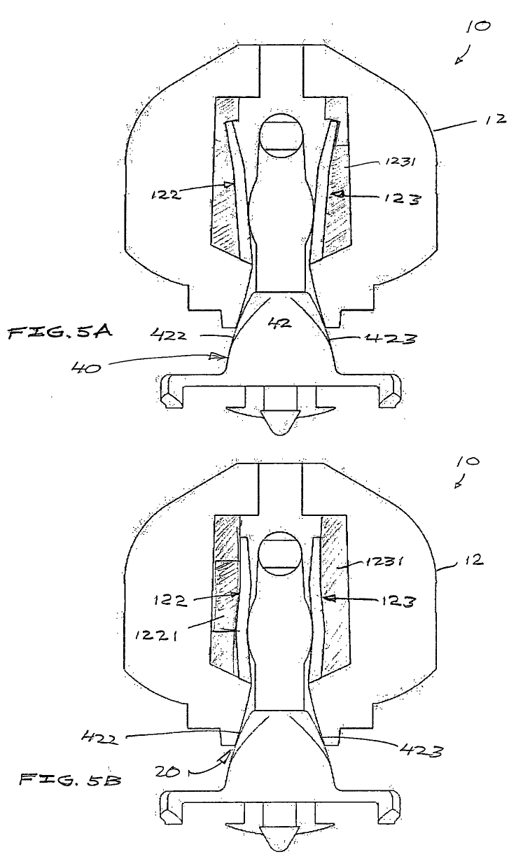

With continuing reference to FIGS. 1 and 2, and further reference to FIGS. 3, 4, 5 and 6, the latch body 12 includes a fishmouth 20 which is formed or defined by an opening 21 in an external wall 121 of the latch body 12, and first and second interior walls 122 and 123, and an end wall 124. The names for the first and second interior walls 122 and 123 are for reference only and may refer to either of the elongate laterally opposed walls which extend into the latch body 12 from the fishmouth 20, and are alternatively referred to herein collectively as the “walls of the fishmouth”. The interior space of the fishmouth 20 is configured and dimensioned to receive at least the post and bridge components of a latch striker, as further described, so that the catch of the latch engages the post and other portions of the latch striker.

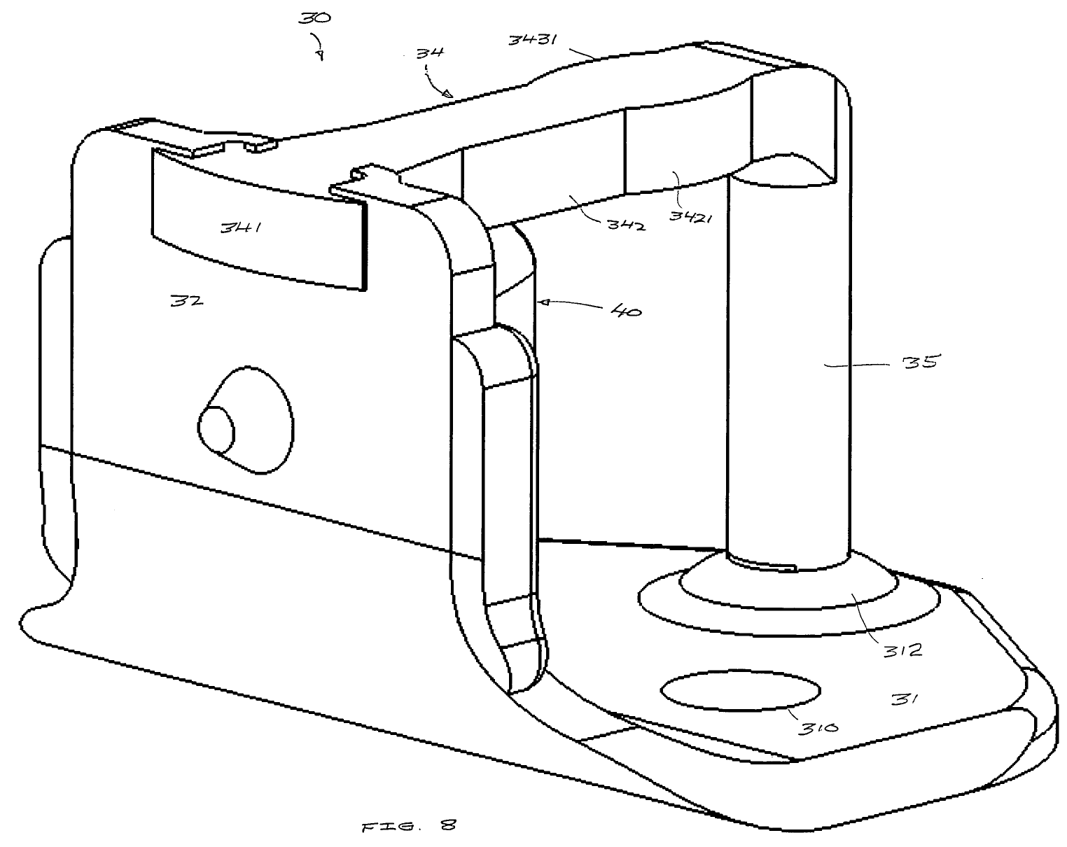

FIG. 7 is representative of one type of latch striker, indicated in its entirety at 30, which is part of the disclosure. As further explained, the disclosure is not limited to any particular type of latch striker apart from the novel features of the latch strikers and the cooperation and engagement of such novel features with latches. The particular latch striker 30 has a base 31 which serves as a mounting structure through which fasteners extend through holes 310 to mount and secure the latch striker to a surrounding structure such as a door frame of an automobile car body. Extending from or otherwise attached to the base 31 is a back wall 32 which also serves as a structural feature of the latch striker and which can be used as an additional mounting structure or surface through which fasteners may be installed. As known in the art, the base 31 and back wall 32 can be formed from a single piece of material such as steel, and in that sense may be regarded as a single piece or structure. Also, the dimensions and configurations of the base 31 and back wall 32 may be designed for any particular application.

The latch striker 30 further includes a bridge 34 and post 35. The bridge 34 extends from the back wall 32 to the post 35. The post 35 extends from the base 31 to the bridge 34. Although formed as a single piece, such as a single piece of stamped steel, the bridge 34 and post 35 are sometimes referred to herein separately or as separate components. The bridge 34 is connected to the back wall 32 by any suitable connection, such as by weld or fastener(s). As further shown in FIG. 8, a mechanical lock can be formed between the end 341 of the bridge and a perimeter region of the back wall 32. For example, grooves or channels 3411 are formed in the side walls 342 and 343 of the bridge proximate to end 341 into which fit terminated wall sections 321 of the back wall 32. A head portion 3412 is formed beyond the channels 3411 to lock over the back wall 32. The resulting locking engagement of the bridge 34 with the back wall 32 can be secured by welding, punching or other deformation of the interfacing structures. The machined or molded configurations, such as channels 3411 and terminated wall sections 321 are preferably orthogonal and linear to simplify manufacture and assembly. For example, to assemble the latch striker 30, the end 341 of the bridge 34 can be easily linearly inserted into the corresponding opening in the back wall 32, as the end of post 35 is inserted into or through the base 31, as further described.

A distal end 351 of the post 35 fits into or through the base 31 or through a boss 312 in the base 31 and is secured thereto by stamping, welding or other permanent interconnection. The exterior configuration of the portion of the post 35 between the base 31 and the bridge 34 is shown as cylindrical, which is the most common configuration for engagement with the catch of a latch, but any other configuration or shape is possible including oblate, elliptical or spherical, as further explained. The distal end 351 of the post 35 can be formed as a double D as shown for location and locking with the base 31.

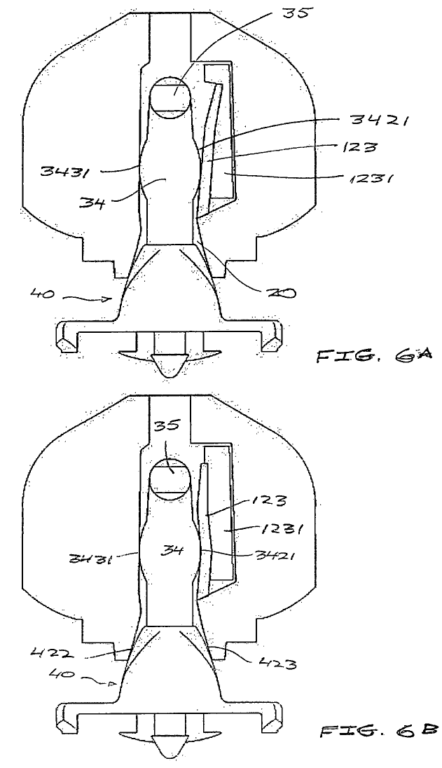

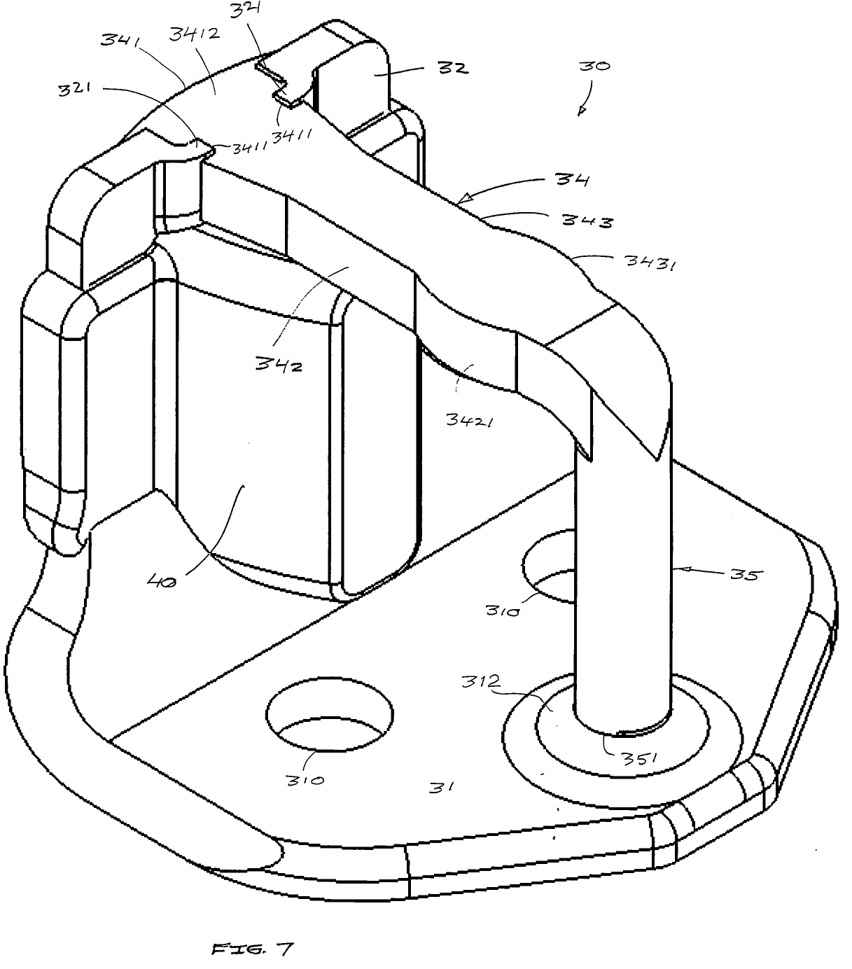

The bridge 34 has first and sides walls 342 and 343, alternatively referred to simply as “sides” or “sides of the bridge”. The names “first” and “second” for sides 342 and 343 of the bridge are for identification and differentiation only and can be and are interchanged and used alternatively herein, and collectively referred to as the “sides of the bridge”. The sides of the bridge are configured for optimal interface with the fishmouth of the latch, and particularly with the walls 122, 123 of the fishmouth, to reduce or eliminate chucking an noise generation. As shown in FIGS. 1-6, at least one or both of the sides 342 or 343 of the bridge 34 has a contoured non-linear (i.e., not straight) profile 3421, 3431 which projects outward from a centerline of the bridge. In the latch and latch striker interface of the disclosure, at least one of the interior walls 122 or 123 (FIGS. 5B and 6B) or both (FIGS. 5A and 6A) of the fishmouth 20 are at least partially flexible, meaning that at least some portion of the wall 122 or 123 will flex in response to pressure from contact by a protruding profile 3421, 3431 of the bridge sides. The flexibility of the wall 122, 123 is preferably such that it not only flexes or deforms in response to pressure from the protruding profile 3421 or 3431 of the bridge 34, but also generally conforms to the protruding profile when the latch striker 30 is fully engaged with the latch within the fishmouth 20. Depending upon the degree of flexibility of the walls 122, 123 and the properties of the material(s) from which they are made, the degree of contact of the walls with the bridge sides 122, 123 may vary anywhere from essentially single point contact, to conforming contact wherein the flexible portion of the bridge side wall 122 or 123 is in contact with a substantial portion of the corresponding protruding profile 3421 or 3431 of the bridge side walls. It is the protruding profile of one or both of the side walls 122, 123 of the bridge 34 in combination with a flexible side wall 122, 123 that provides a superior latch and latch striker interface which reduces noise and chucking. The one or more protruding profiles of the bridge of the latch striker deform the flexible portion of the walls of the fishmouth when the latch striker is fully engaged with the latch.

One type of latch which can be used in accordance with the disclosure has a flexible fishmouth side wall 123 behind which is an elastomeric piece 1231 which contributes to or augments the flexibility of the side wall 123 and its flexible contact with the side wall of the bridge 34. As shown in FIGS. 5A and 5B, both walls 122 and 123 may be similarly configured and similarly flexible and each with a corresponding elastomeric body 1221, 1231, to form effectively a symmetrical fishmouth 20 which engages with a symmetrically configured bridge 34 having symmetrical protruding profiles 3421 and 3431. This symmetrical configuration effectively doubles the described advantage of the interface between the protruding profiles of the bridge side walls 342, 343 and the side walls 122, 123 of the fishmouth 20. As shown in FIG. 5B, the elastomeric body 1231 is initially compressed by the movement of wall 123 which displaced by contact with the protruding profile 3421 of the bridge 34. As shown in FIG. 6B, with the latch striker 34 fully engaged within the fishmouth 20, the flexible wall 123 (or flexible portion thereof) is urged into contact with the protruding profile 3421 of the bridge 34 by the elastomeric body 1231 to provide the improved latch striker and latch interface as described. In other words, the flexible wall 123 (of flexible portion thereof) remains in a deformed or deflected state as a result of contact with the protruding profile of the bridge 34.

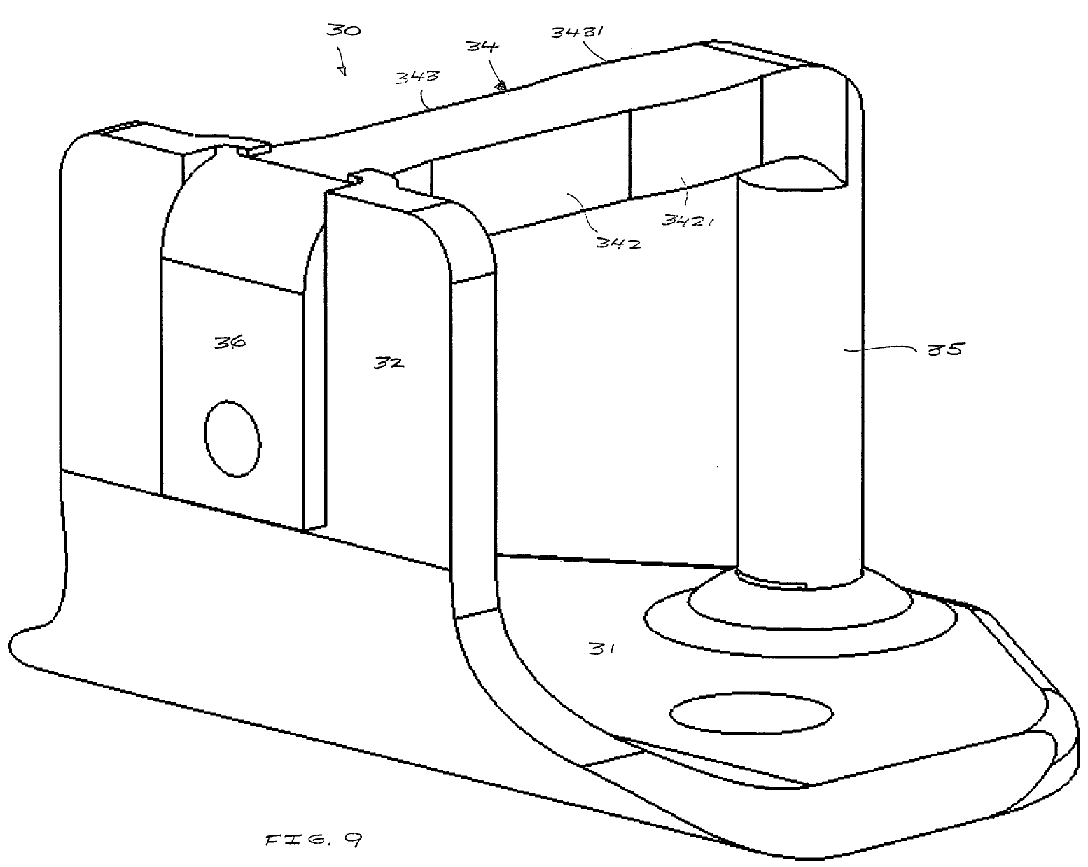

FIG. 9 illustrates an alternate embodiment of a type of latch striker 30 which can be used in accordance with the invention, which includes a bridge 34 with the described protruding profiles 3421 and 3431. In this particular embodiment the bridge 34 extends between a post 35 and a heel 36 which mechanically locks with the wall 32 of the striker base or mount.

FIG. 10 illustrates another embodiment of a type of latch striker 30 which can be used in accordance with the invention, which includes a bridge 34 with the described protruding profiles 3421 and 3431. In this particular embodiment the heel 36 terminates at a distal end 361 which is mechanically locked with the base or mount 31 of the striker 30, and which may be permanently so located by a punch or other displacement or deformation operation such as welding.

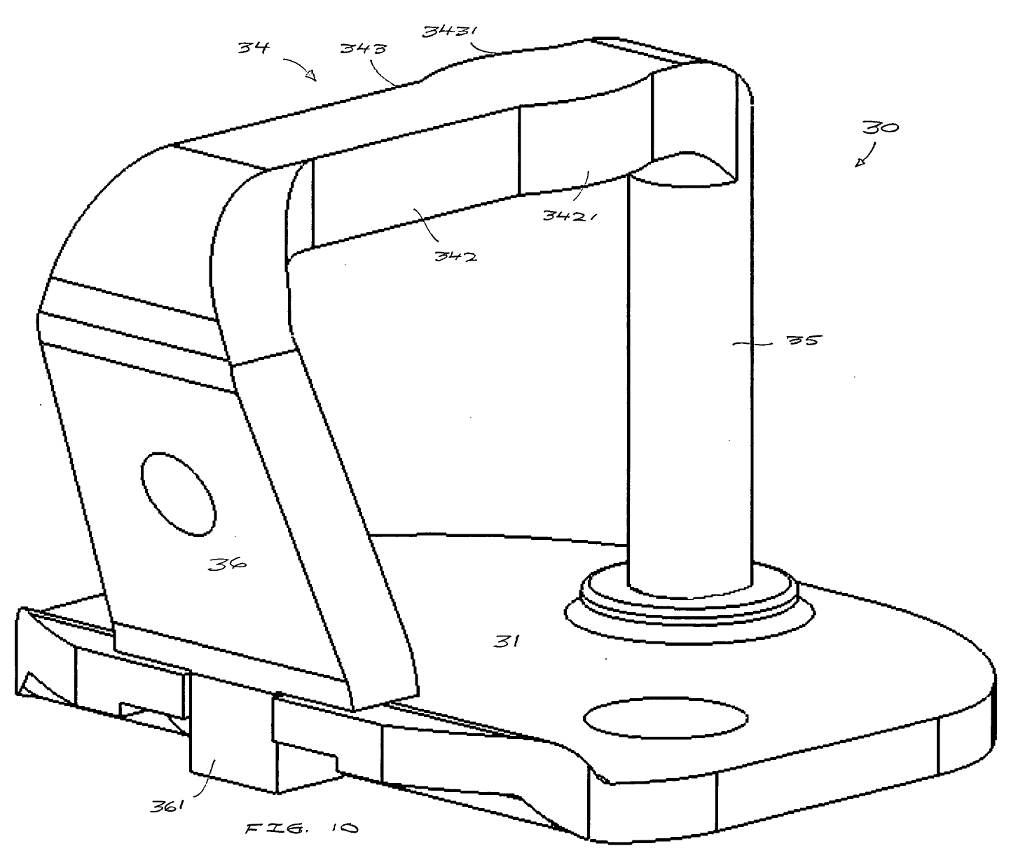

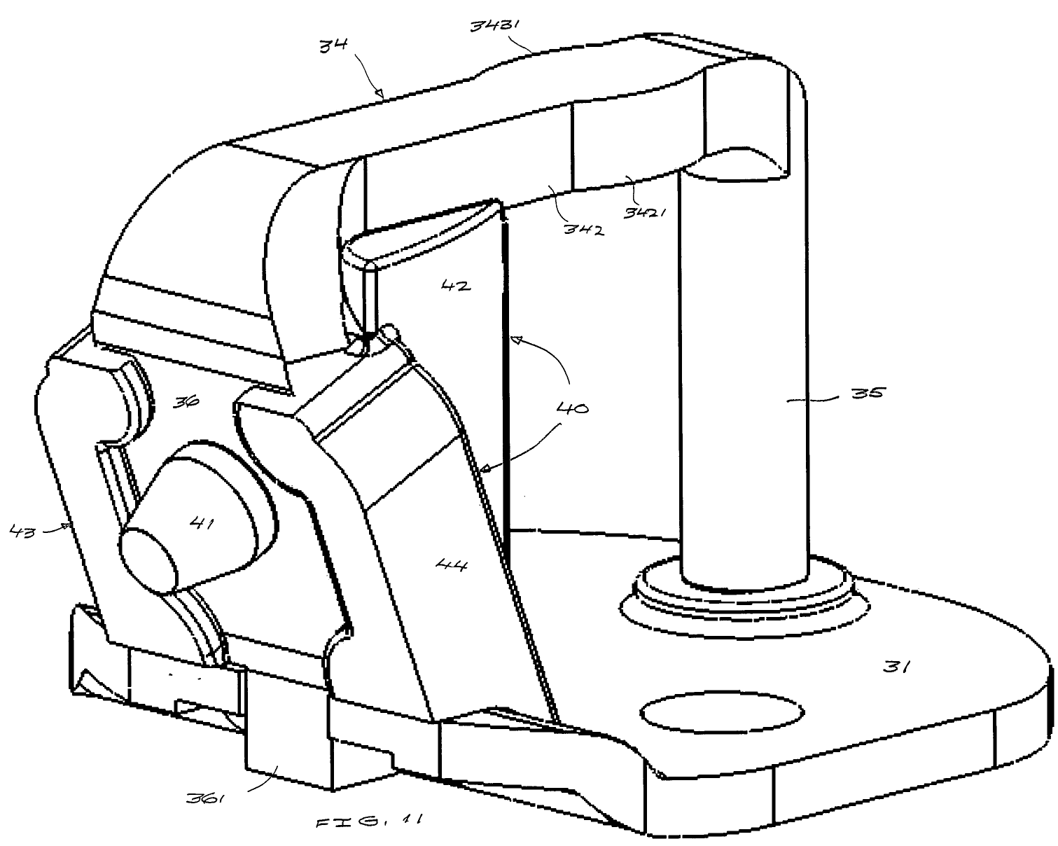

FIGS. 11 and 12 illustrate the latch striker 30 of FIG. 10 further including a fitting plug 40. The fitting plug 40 is mounted through the heel 36 by the stopper head 41 which is connected to a main body 42 which extends from the heel 36 toward the post 35 and under the bridge 34. Side sections 43 and 44 of the fitting plug 40 fit laterally about the heel and may at least partially encapsulate the heel 36 as shown. As shown in FIGS. 1-6, the main body 42 of the fitting plug 40 fits within the fishmouth 20 preferably so that the side walls 422 and 423 of the main body 42 contact or compressively contact the entrance or opening to the fishmouth 20, so that at least a portion of the main body 42 is located within the fishmouth 20 when the latch striker 30 is engaged with the latch 10. The fitted plug 40 thus provides a seal to the interior of the latch body 12 at the fishmouth 20 and provides additional and significant anti-vibration and anti-chucking function.

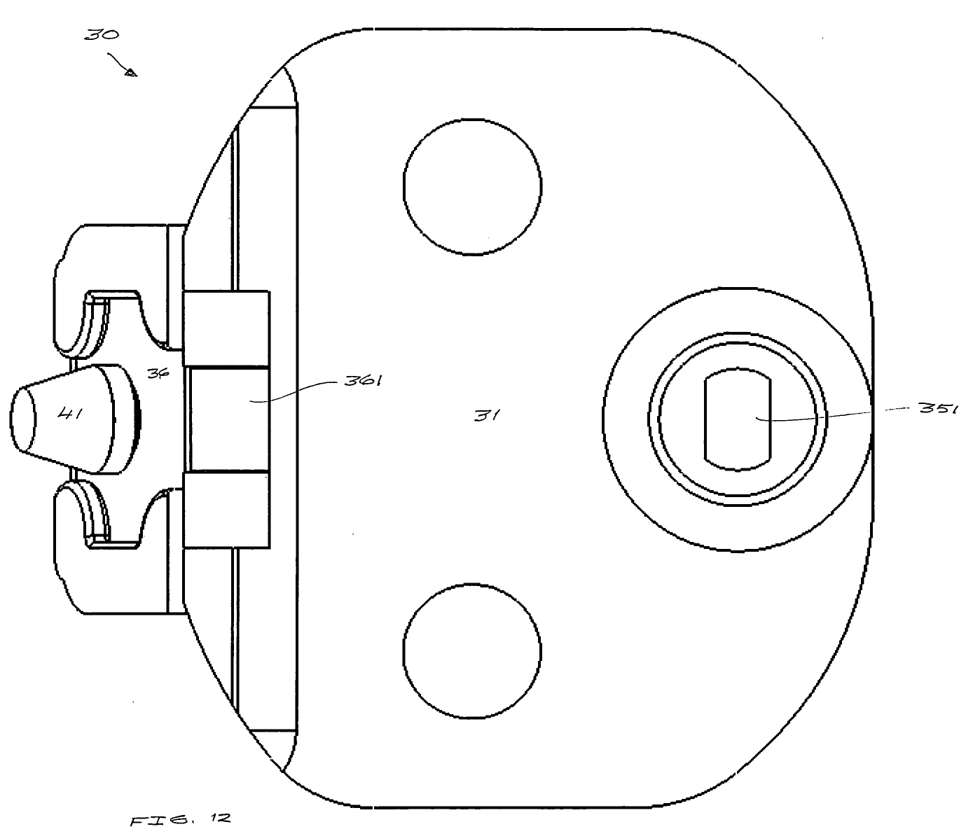

In the latch striker embodiment of FIGS. 13 and 14, the distal end 361 of the heel 36 extends through an offset section 320 which extends from base or mount 31. The fitting plug 40 can be configured to fit closely with the heel 36 as described, and with the base 31 and section 320.

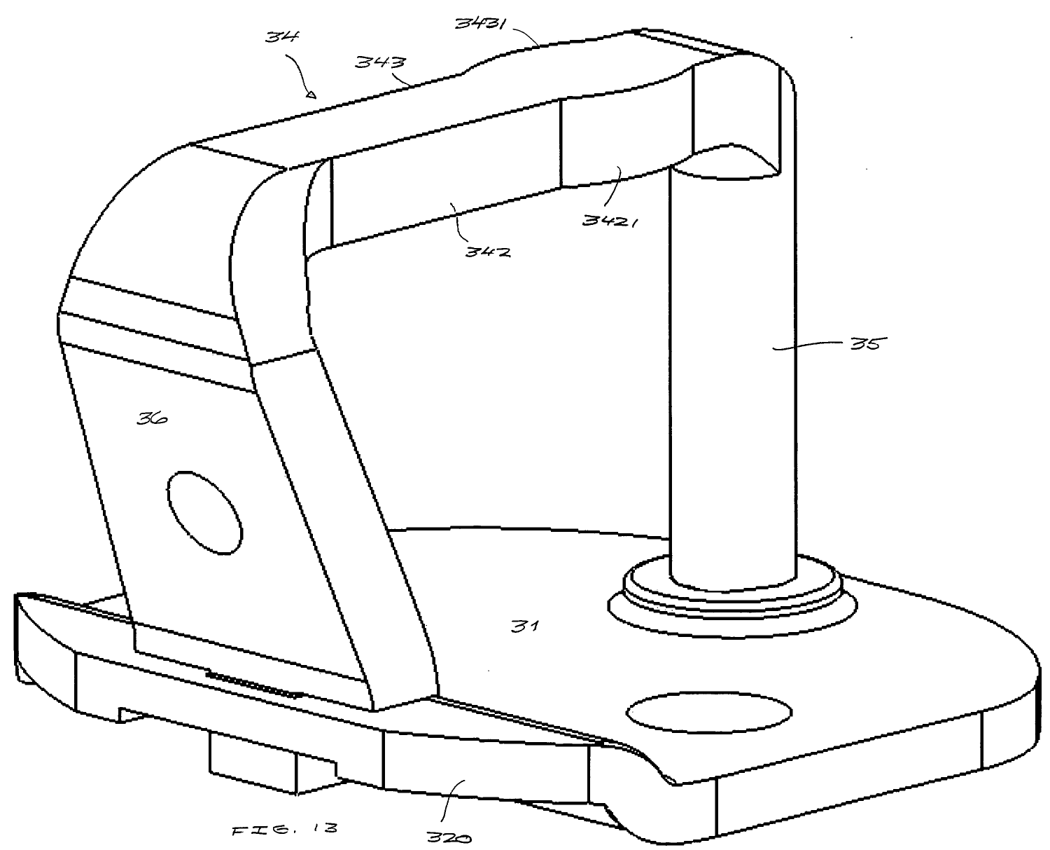

FIGS. 15-18 illustrate various embodiments of the bridge, post and heel components of latch striker configurations of the disclosure which can be used to practice the invention. FIGS. 15A and 15B illustrate a bridge 34 with symmetrical protruding profiles 3421 and 3431 similar to that shown in FIGS. 5A, 5B, 6A and 6B, and which can be used with a latch with a fishmouth 20 having one or two flexible side walls.

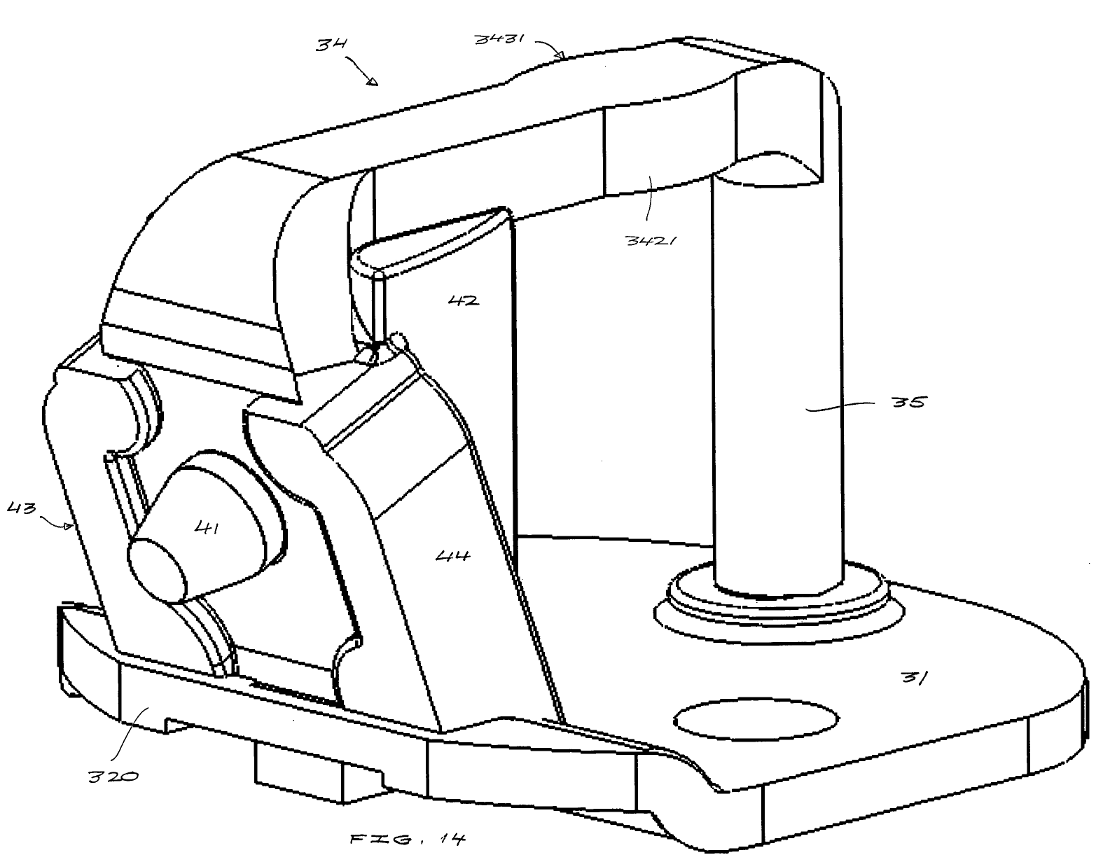

FIGS. 16A and 16B illustrate a bridge which has a protruding profile 3421 on one side 342, and a continuous but curved profile on the opposite side 343, designed for use with a latch in which the fishmouth has at least one flexible wall which works in cooperation with the protruding profile 3421 as described.

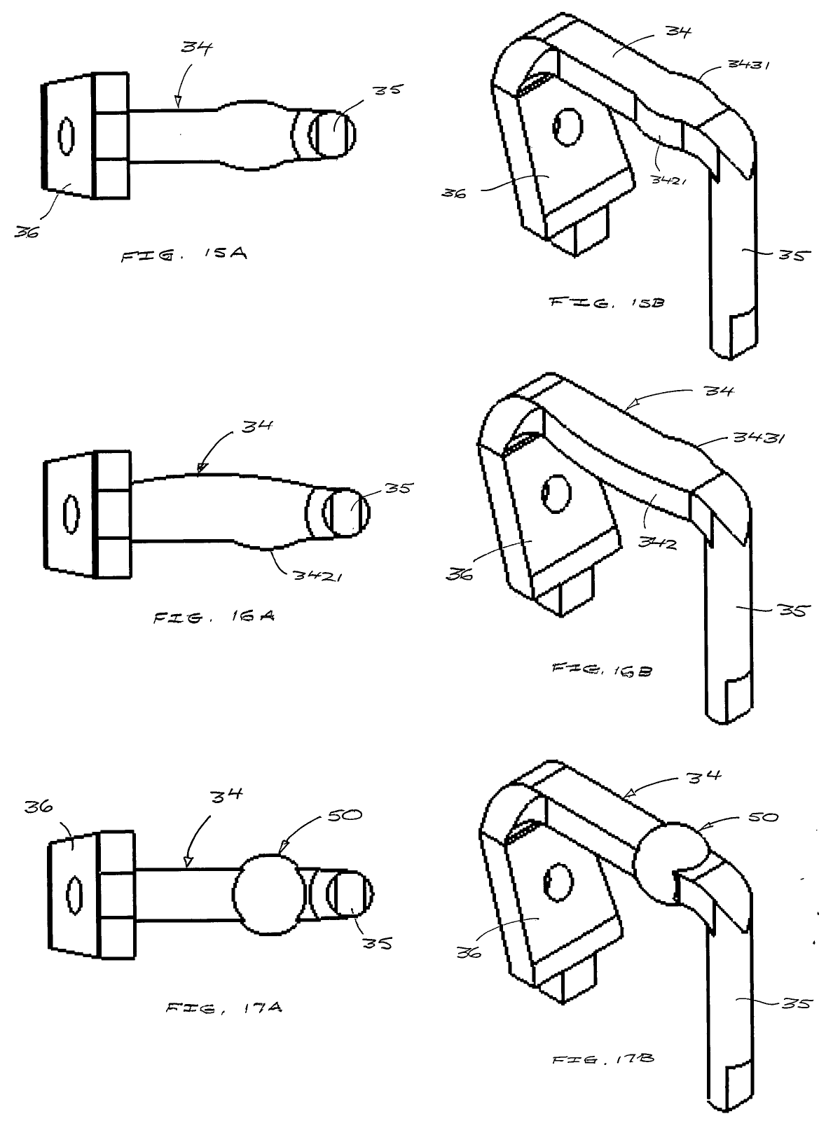

FIGS. 17A and 17B illustrate another type of bridge 34 in which a spherical element 50 is incorporated into the bridge configuration for contact with one or more flexible surfaces or structures inside the fishmouth of a latch. The spherical element 50 provides stabilizing contact with the fishmouth of the latch in any direction and under any pattern of movement as caused by repeated operation or vibration.

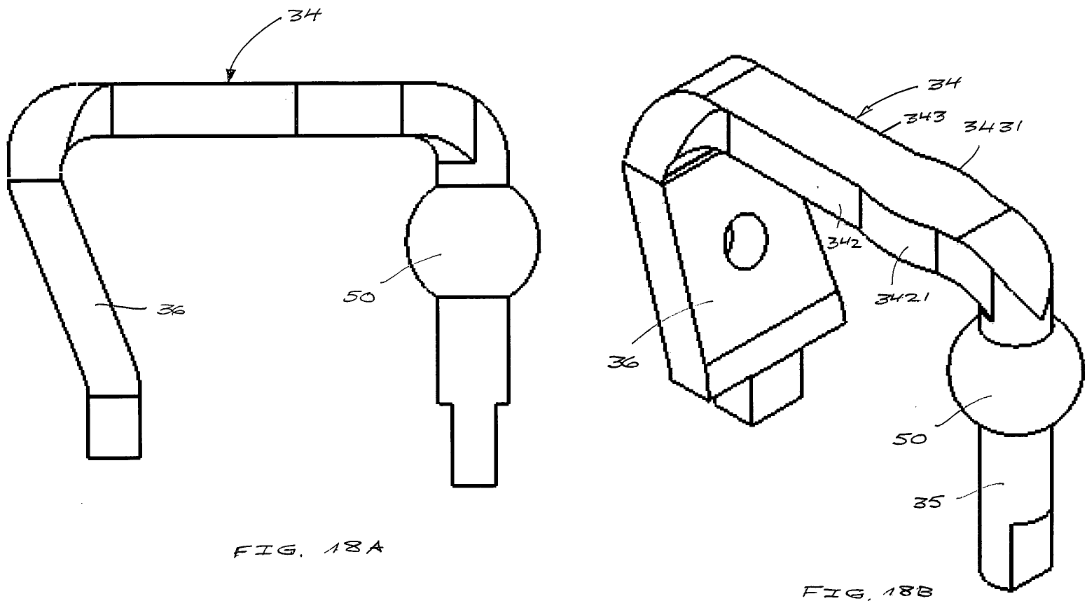

FIGS. 18A and 18B illustrate an alternate embodiment of the bridge, heel and post components of latch striker of the disclosure wherein a spherical element 50 is formed or fitted upon the post 35 for multi-degree contact with a suitably configured latch fishmouth 20 and latch clasp.

1. A latch and latch striker combination comprising:
a latch with a latch body, the latch mechanism including a rotationally mounted catch, the latch mechanism operative to move the catch between an open position and a latched position;
a fishmouth formed in the latch body, the fishmouth having an opening to an exterior of the latch body, and interior first and second opposed walls, at least one of the first or second opposed walls of the fishmouth being at least partially flexible;
a latch striker having a bridge and a post which extends from a distal end of the bridge, the bridge and post of the latch striker configured to fit substantially within the fishmouth of the latch body;
the bridge having first and second sides, the first side facing the first wall of the fishmouth when the latch striker is positioned substantially within the fishmouth of the latch body, and the second side facing the second wall of the fishmouth when the latch striker is positioned substantially within the fishmouth of the latch body;
at least one of the sides of the bridge having a protruding profile which contacts and deforms the at least one of the first or second opposed walls of the fishmouth which is at least partially flexible when the latch striker is fully engaged with the latch.

2. A latch striker for engagement with a latch having a latch body and a fishmouth in the latch body, at least one of the walls of the fishmouth having a flexible portion, the latch striker having a base, a heel, a post and a bridge which extends between the heel and the post, the bridge having a protruding profile configured to contact and displace the flexible portion of the at least one of the walls of the fishmouth.

3. The latch striker of claim 2 wherein the bridge has a protruding profile on one side of the bridge.

4. The latch striker of claim 2 wherein the bridge has a protruding profile on two sides of the bridge.

5. The latch striker of claim 2 wherein the at least one protruding profile of the bridge has a curvilinear contour which extends away from a centerline of the bridge and is located between the heel and the post.

6. The latch striker of claim 2 wherein the at least one protruding profile of the bridge is generally spherical.

7. The latch striker of claim 2 wherein the bridge has symmetrical sides.

8. A latch striker and latch combination comprising:
a latch with a latch body and a fishmouth in the latch body, the fishmouth having first and second side walls, at least one of the first or second side walls being at least partially flexible;
a latch striker having a base, a heel and a post connected to the base, and a bridge which extends between the heel and the base, the bridge and post configured for insertion into the fishmouth of the latch, the bridge having generally opposed sides and a protruding profile on at least one of the opposed sides, the at least one protruding profile extending away from a centerline of the bridge and contacting and deforming one of the first or second walls of the fishmouth of the latch body, and
a fitted plug attached to the latch striker, the fitted plug having a main body located between the bridge and the base and configured for partial insertion into the fishmouth of the latch body and wherein the main body of the fitted plug is partially inserted into the fishmouth when the post and bridge are located within the fishmouth.

9. The latch striker and latch combination of claim 8 wherein the fitted plug substantially fills an opening in the latch body to the fishmouth when the latch striker is fully engaged with the latch.

10. The latch striker and latch combination of claim 8 wherein the at least one protruding profile of the bridge of the latch striker is curvilinear and extends away from a centerline of the bridge and is located between the heel and the post.
